(19) United States
(12) Patent Application Publication
(10) Pub. No.: US 2013/0340332 A1
(43) Pub. Date: Dec. 26, 2013

(54) DECORATIVE YARD ORNAMENTS AS PLANTERS FOR FLOWER BEDS AND THE YARD

(71) Applicant: Dell Culver, Overland Park, KS (US)

(72) Inventor: Dell Culver, Overland Park, KS (US)

(21) Appl. No.: 13/911,786

(22) Filed: Jun. 6, 2013

Related U.S. Application Data
(60) Provisional application No. 61/656,224, filed on Jun. 6, 2012.

(51) Int. Cl. A01G 9/02

(52) U.S. Cl. CPC A01G 9/02
USPC 47/33

(57) ABSTRACT

An ornamental planter device that is used for decorating lawns and gardens. In various embodiments, it includes a colorful flower, bird and insect, each fastened on the end of a stake. Each has a planter on the back so a gardener may plant their choice of flower. A detachable screw is screwed in the ground and each stake is attached with a secure fastener. The stake is easy to unfasten for mowing.

### CLAIM OF PRIORITY

This application claims priority to U.S. Provisional Patent Application Ser. No. 61/656224 filed Jun. 6, 2012 entitled “Decorative Yard Ornaments as Planters for Flower Beds and the Yard”, and is herein incorporated by reference in its entirety.

### FIELD OF THE INVENTION

The invention relates generally to a decorative yard ornamental planters to put in flower beds or in a yard.

### BACKGROUND

Currently there are a number of solutions for decorating a lawn with simple planters. Some of these solutions attempt to make planting easier, but these solutions fail to meet the needs of the industry because they do not have a planter attached, are not easy to remove for mowing, and are very expensive. Other solutions attempt to make decorating a lawn easier, but these solutions are similarly unable to meet the needs of the industry because they do not have a planter on the back side.

It would be desirable to have a composition that was a colorful ornamental device that serves as a planter for the yard or garden. . Furthermore, it would also be desirable to have a decorating system that is easily removed from the lawn. Therefore, there currently exists a need in the industry for a decorating system that is decorative but easy to use.

### SUMMARY

The invention advantageously fills the aforementioned deficiencies by providing a decorative or ornamental planter for a flower bed or yard in the form of a flower, bird, or insect design on a stake, thereby providing those who have gardens or lawns with a simple decorating solution.

In one example embodiment, there is provided a large screw on each stake and a colorful flower, bird and insect or the like with each having a little planter on the back. Each of the ornamental configurations is at the top of an individual stake. The bottom of the stake has a fastener. A separate screw is screwed into the ground with a handle that is provided, and then the stake is turned into the top of the screw and it becomes one unit. Units come in either 2′ or 4′ lengths.

Each stake is easily unscrewed from the ground and moved from area to area. The planter on each provides the gardener the opportunity to individualize each planter with their favorite plantings. The screw on the end of the stake makes for easy placement of the planters. Among other things, an advantage of the present invention is to provide gardeners with a simple decorative solution that does not suffer from any of the problems or deficiencies associated with prior solutions.

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 shows a perspective view of a stake including a fastener and a screw.

FIGS. 2A-C show a side perspective view of the stake and planter portion of the decorative system.

### DETAILED DESCRIPTION

The present invention is directed to a means for gardeners to easily decorate their lawns and gardens without complicating the process of mowing the lawn.

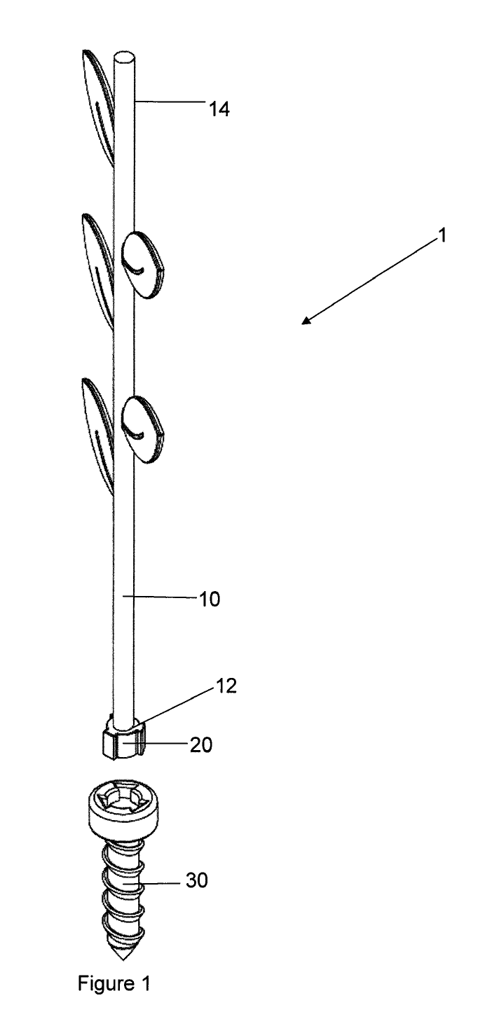

FIG. 1 shows a perspective view of a stake including a fastener and a screw.

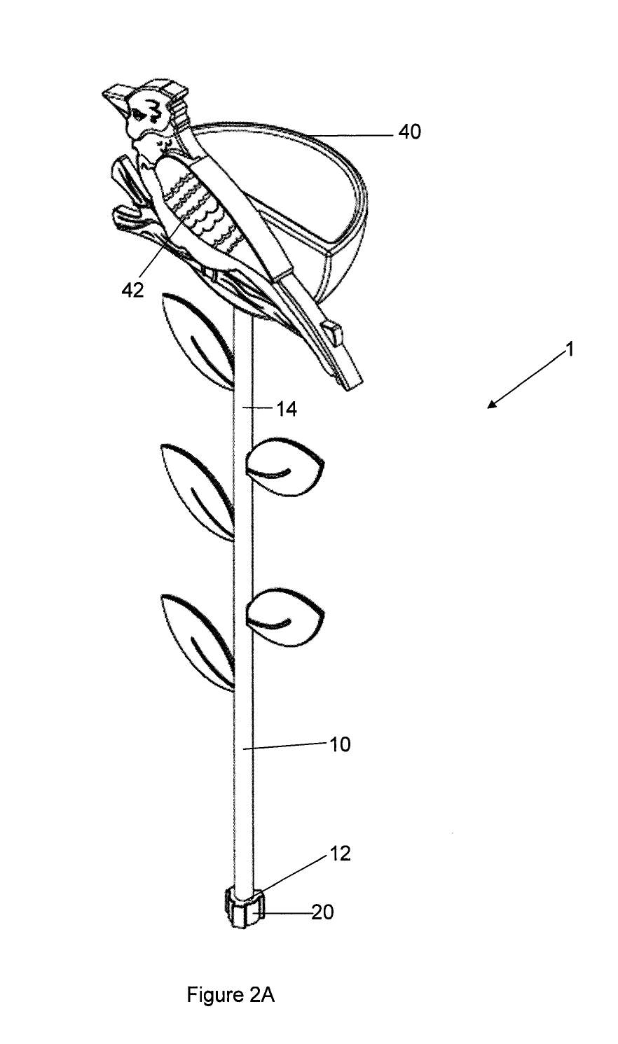

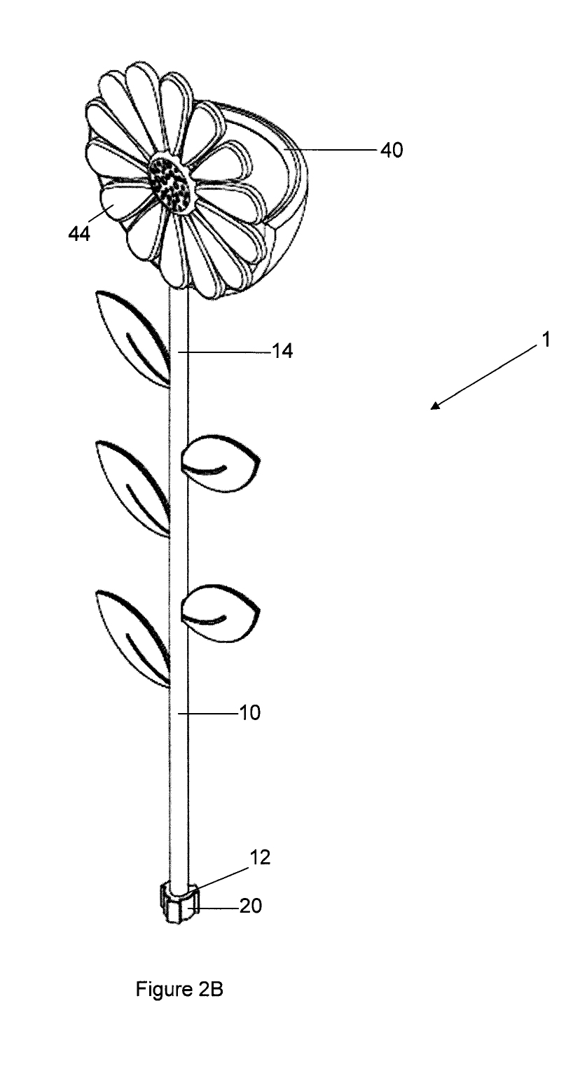

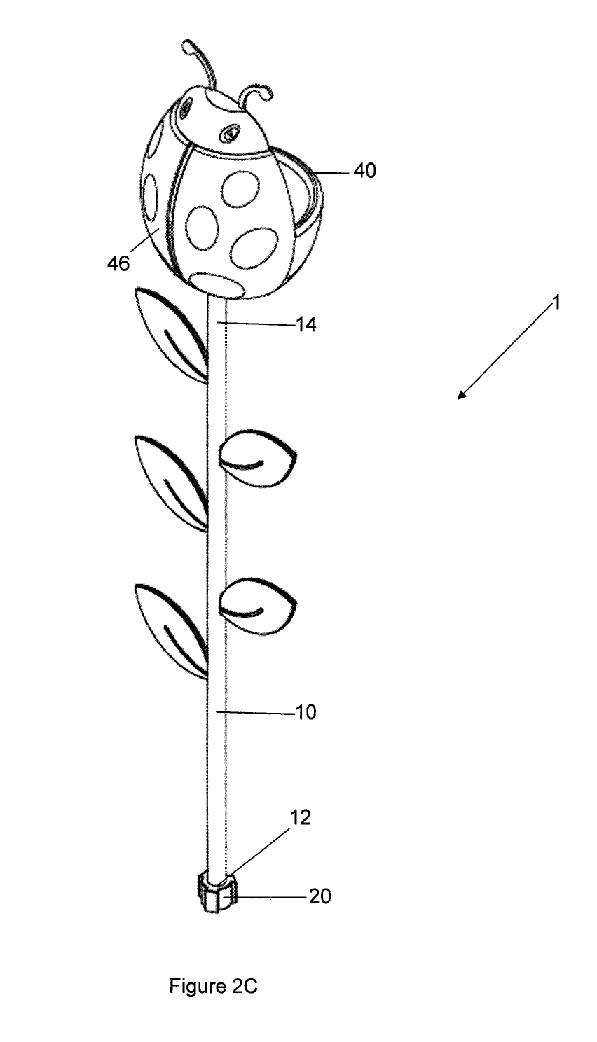

FIGS. 2A-C show a side perspective view of the stake and planter portion of the decorative system.

In one example embodiment, there is provided a screw on at least one end of a stake and a colorful flower, blue jay and/or insect (or any other decorative item) each having a little planter on the back. Each is the top of an individual stake. The bottom of the stake has a fastener. A separate screw is screwed into the ground with a handle that is provided, then the stake is turned into the top of the screw and becomes one unit. In a related example embodiment, the planter or decorative device at the top of the stake can be substituted for a reflective device and be used in the summer or winter in the driveway to easily insertable and removable reflectors which is difficult to do in the snow or ice when have to plow.

Referring now to FIG. 1, stake 10 having a first end 12 and second end 14. Stake 10 can be manufactured from a number of materials known by one of ordinary skill in the art. In related embodiments the stake material is selected from a group consisting of metal or plastic or wood. First end 12 is coupled to fastener 20. Fastener 20 provides for stake 10 to be coupled to screw 30. Screw 30 provides a means to removeably dispose yard stake system 1 from a surface, such as a flower bed or yard.

Now referring to FIGS. 2A-C, in a related embodiment, stake 10, is coupled to a planter 40. Planter 40 may be permanently or removeably coupled to stake 10. Planter 40 may comprise a decorative element such as a bird 42, flower 44 or insect 46. Other decorative elements may also be coupled to the planter. Decorative elements that would be found in lawn and garden uses are known by a person of ordinary skill in the art.

While the present invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

1. A yard stake system comprising:
a screw
a stake having a first end and a second end said first end providing a fastener to couple said screw to said stake and
a planter bed
wherein said screw being coupled to said fastener which provides a means of engaging the yard stake system to a surface, said planter bed being disposed on said second end.

2. A yard stake as in claim 1, wherein said planter bed further comprises a decorative element.

3. A yard stake as in claim 2, wherein said decorative portion is selected from a group consisting of a bird, a flower, and an insect.

4. An ornamental planter device for a garden or flower bed as substantially described herein.
